(19) United States
(12) Patent Application Publication
(10) Pub. No.: US 2017/0009053 A1
(43) Pub. Date: Jan. 12, 2017

(54) Nanocomposite Mooney Viscosity Stability

(71) Applicant: EXXONMOBIL CHEMICAL PATENTS INC., Baytown, TX (US)

(72) Inventors: Yuan-Ju Chen, Houston, TX (US); John P. Soisson, Houston, TX (US); Luke P. Stephens, Humble, TX (US); Michael B. Rodgers, Cedar Park, TX (US); Marvin C. Hill, Spring, TX (US)

(21) Appl. No.: 15/114,312

(22) PCT Filed: Dec. 15, 2014
(86) PCT No.: PCT/US2014/070311

§ 371 Date: Jul. 26, 2016

Related U.S. Application Data
(60) Provisional application No. 61/946,035, filed on Feb. 28, 2014.

(51) Int. Cl. C08K 5/09; C08L 9/00; C08K 9/04

(52) U.S. Cl. CPC C08K 5/09; C08K 9/04; C08L 9/00; C08L 2207/04; C08K 2201/011

(57) ABSTRACT

This invention relates to an elastomeric nanocomposite composition, the composition comprising at least one elastomer, at least one nanofiller, and an ionomer stabilizer in the amount of at least about 0.5 phr of the composition, the elastomer comprising units derived from isoolefins having from 4 to 7 carbon atoms and at least one multiolefin, and the nanofiller consisting of a layered filler, wherein the stabilizer is added to improve the stability of the Mooney viscosity of the composition over time.

### PRIORITY

This invention claims priority to and the benefit of U.S. Ser. No. 61/946,035, filed Feb. 28, 2014.

### FIELD OF THE INVENTION

The invention relates to an elastomeric nanocomposite with improved Mooney viscosity stability over time.

### BACKGROUND OF THE INVENTION

The present invention is related to elastomeric nanocomposites particularly useful for tire and other industrial rubber applications that require stability of Mooney viscosity over time.

Rubbery polymers containing a majority of isobutylene units are well known for their low gas permeability, unique damping properties, and low surface energy; these properties make such copolymers particularly desired in applications such as tire innerliners. The tire industry has always been interested in enhancing the barrier properties of tires. One way to improve the barrier properties is to mix them with layered fillers, such as layered clays, to form an elastomeric nanocomposite.

However, in producing an elastomeric nanocomposite, the incompatibility between the hydrophobic polyolefin elastomer and the hydrophilic inorganic clays can make it very difficult to achieve a good clay dispersion or exfoliation within the elastomer. Much effort has been made to modify the clay or the elastomer to make the two elements more compatible. The nanoclay can be modified by adding a chemical additive, such as a surfactant, to render the nanoclay compatible with non-polar polymers, or through processing methods such as the formation of an emulsion dispersible in a polymer network or matrix. A nanoclay that has been modified is generally referred to in the art as an organoclay.

The organoclay components of nanocomposites are generally produced by adding one or more quaternary ammonium salts. Such salts inherently contain amines as impurities which can form ionomers and covalent crosslinks. Such salts can also undergo degradation reactions forming additional reactive amines, as described by L. Cui, D. M. Khramov, C. W. Bielawski, D. L. Hunter, P. J. Yoon, D. R. Paul, EFFECT OF ORGANOCLAY PURITY AND DEGRADATION ON NANOCOMPOSITE PERFORMANCE, PART 1: SURFACTANT DEGRADATION, Polymer 49 (2008) 3751-61. The presence of these amines ultimately leads to an unfavorable increase in the Mooney viscosity of the elastomeric nanocomposite, thereby limiting product shelf life and reducing the processability of innerliner compounds.

U.S. Pat. No. 8,461,240 discloses a nanocomposite comprising an elastomer and a nanofiller, wherein unassociated amines have been removed from the nanofiller. Likewise, it is generally known to acid treat the organoclay to protonate amine impurities; thereby stabilize the Mooney viscosity of the nanocomposite. However, there is still a need to further improve the stability of nanocomposites in an economic manner.

### SUMMARY OF THE INVENTION

The foregoing and/or other challenges are addressed by the products and methods disclosed herein.

In one aspect, the present invention is directed to an elastomeric nanocomposite composition, the composition comprising at least one elastomer, at least one nanofiller, and an ionomer stabilizer in the amount of at least about 0.5 phr of the composition, the elastomer comprising units derived from isoolefins having from 4 to 7 carbon atoms and at least one multiolefin, and the nanofiller consisting of a layered filler, wherein the Mooney viscosity (ML, 1+8 at 125° C.) of the composition does not increase by more than about 7.5 Mooney units for up to about 8 weeks at 80° C.

### BRIEF DESCRIPTION OF THE FIGURES

FIG. 1 shows the change in Mooney viscosity with the addition of 1 phr and 2 phr of stearic acid.

FIG. 2 shows the change in Mooney viscosity with the addition of 2 phr stearic acid prior to compounding.

### DETAILED DESCRIPTION OF THE INVENTION

Various specific embodiments of the invention will now be described, including preferred embodiments and definitions that are adopted herein for purposes of understanding the claimed invention. While the illustrative embodiments have been described with particularity, it will be understood that various other modifications will be apparent to and can be readily made by those skilled in the art without departing from the spirit and scope of the invention. For determining infringement, the scope of the “invention” will refer to any one or more of the appended claims, including their equivalents and elements or limitations that are equivalent to those that are recited.

The inventors have discovered that some classes of stabilizers, known as ionomer stabilizers, can assist in suppressing the increase in molecular weight of elastomeric polymers, thereby reducing the amount of Mooney viscosity growth of the polymer. One or more of these stabilizers may be added to both acid-pretreated organoclay and non-pretreated organoclay. As rubber formulators generally add stearic acid to prepared bromobutyl elastomers as part of the curative package, it is expected that adding certain ionomer stabilizers, such as stearic acid, to improve the stability of Mooney viscosity can also serve to reduce the amount of stearic acid necessary for curative purposes.

Accordingly, the present invention is directed to an elastomeric nanocomposite comprising an ionomer stabilizer to improve the stability of the Mooney viscosity of the composition over time.

### Definitions

Definitions applicable to the presently described invention are as described below.

For the purpose of this specific application, the term “composition” means the elastomeric polymer to which the ionomer stabilizer has been added. The polymer itself may already be modified by the inclusion of other amine modifiers or by acid treatment, as discussed both above and further below in the examples. The user of the inventive composition will create what is considered conventionally as “compositions” in that the user will add fillers, curatives, and other ingredients to create a fully formulated composition useful as a finished article such as a curing bladder or for use in a finished article such as a tire innerliner, air diaphragm, or hose.

Mooney viscosity refers to the viscosity measure of rubbers. It is defined as the shearing torque resisting rotation of a cylindrical metal disk (or rotor) embedded in rubber within a cylindrical cavity. The dimensions of the shearing disk viscometer, test temperatures, and procedures for determining Mooney viscosity are defined in ASTM D1646.

Rubber refers to any polymer or composition of polymers consistent with the ASTM D1566 definition: “a material that is capable of recovering from large deformations, and can be, or already is, modified to a state in which it is essentially insoluble (but can swell) in boiling solvent . . . ”. Elastomer is a term that may be used interchangeably with the term rubber. Elastomeric composition refers to any composition comprising at least one elastomer as defined above.

A vulcanized rubber compound by ASTM D1566 definition refers to “a crosslinked elastic material compounded from an elastomer, susceptible to large deformations by a small force capable of rapid, forceful recovery to approximately its original dimensions and shape upon removal of the deforming force.” A cured elastomeric composition refers to any elastomeric composition that has undergone a curing process and/or comprises or is produced using an effective amount of a curative or cure package, and is a term used interchangeably with the term vulcanized rubber compound.

The term “phr” is parts per hundred rubber or “parts”, and is a measure common in the art wherein components of a composition are measured relative to a total of all of the elastomer components. The total phr or parts for all rubber components, whether one, two, three, or more different rubber components is present in a given recipe is always defined as 100 phr. All other non-rubber components are ratioed against the 100 parts of rubber and are expressed in phr. This way one can easily compare, for example, the levels of curatives or filler loadings, etc., between different compositions based on the same relative proportion of rubber without the need to recalculate percents for every component after adjusting levels of only one, or more, component(s).

Alkyl refers to a paraffinic hydrocarbon group which may be derived from an alkane by dropping one hydrogen from the formula, such as, for example, a methyl group (CH₃), or an ethyl group (CH₃CH₂), etc.

Aryl refers to a hydrocarbon group that forms a ring structure characteristic of aromatic compounds such as, for example, benzene, naphthalene, phenanthrene, anthracene, etc., and typically possess alternate double bonding (“unsaturation”) within its structure. An aryl group is thus a group derived from an aromatic compound by dropping one or more hydrogens from the formula such as, for example, phenyl, or C₆H₅.

Substituted refers to at least one hydrogen group being replaced by at least one substituent selected from, for example, halogen (chlorine, bromine, fluorine, or iodine), amino, nitro, sulfoxy (sulfonate or alkyl sulfonate), thiol, alkylthiol, and hydroxy; alkyl, straight or branched chain having 1 to 20 carbon atoms which includes methyl, ethyl, propyl, isopropyl, normal butyl, isobutyl, secondary butyl, tertiary butyl, etc.; alkoxy, straight or branched chain alkoxy having 1 to 20 carbon atoms, and includes, for example, methoxy, ethoxy, propoxy, isopropoxy, butoxy, isobutoxy, secondary butoxy, tertiary butoxy, pentyloxy, isopentyloxy, hexyloxy, heptryloxy, octyloxy, nonyloxy, and decyloxy; haloalkyl, which means straight or branched chain alkyl having 1 to 20 carbon atoms which is substituted by at least one halogen, and includes, for example, chloromethyl, bromomethyl, fluoromethyl, iodomethyl, 2-chloroethyl, 2-bromoethyl, 2-fluoroethyl, 3-chloropropyl, 3-bromopropyl, 3-fluoropropyl, 4-chlorobutyl, 4-fluorobutyl, dichloromethyl, dibromomethyl, difluoromethyl, diiodomethyl, 2,2-dichloroethyl, 2,2-dibromoethyl, 2,2-difluoroethyl, 3,3-dichloropropyl, 3,3-difluoropropyl, 4,4-dichlorobutyl, 4,4-dibromobutyl, 4,4-difluorobutyl, trichloromethyl, trifluoromethyl, 2,2,2-trifluoroethyl, 2,3,3-trifluoropropyl, 1,1,2,2-tetrafluoroethyl, and 2,2,3,3-tetrafluoropropyl. Thus, for example, a “substituted styrenic unit” includes p-methylstyrene, p-ethylstyrene, etc.

### Elastomers

Preferred elastomers useful in the practice of this invention include a) polymers derived from at least one C₄ to C₇ isoolefin monomer and at least one multiolefin monomer and b) homopolymers of C₄ to C₇ isoolefin monomers. Some such polymers containing predominantly C₄-derived monomers are conventionally referred to as “butyl rubbers.” For the copolymers, the isoolefin derived content in the copolymer is in a range from 70 to 99.5 wt % by weight of the total monomer derived units in one embodiment, and 85 to 99.5 wt % in another embodiment. The total multiolefin derived content in the copolymer is present in the range of mixture from 30 to 0.5 wt % in one embodiment, and from 15 to 0.5 wt % in another embodiment. In yet another embodiment, from 12 to 0.5 wt % of the polymer is multiolefin derived units. In yet another embodiment, from 8 to 0.5 wt % of the polymer is multiolefin derived units. Herein, for the purpose of this invention, multiolefin refers to any monomer having two or more double bonds. In a preferred embodiment, the multiolefin is any monomer comprising two conjugated double bonds and may be an aliphatic or aromatic monomer.

The C₄ to C₇ isoolefin may selected from compounds such as isobutylene, isobutene, 2-methyl-1-butene, 3-methyl-1-butene, 2-methyl-2-butene, 1-butene, 2-butene, methyl vinyl ether, indene, vinyltrimethylsilane, hexene, and 4-methyl-1-pentene. The multiolefin is a C₄ to C₁₄ multiolefin such as isoprene, butadiene, 2,3-dimethyl-1,3-butadiene, myrcene, 6,6-dimethyl-fulvene, hexadiene, cyclopentadiene, alkylstyrene, and piperylene, and other monomers such as disclosed in U.S. Pat. No. 5,506,316.

When the isoolefin is isobutylene, the elastomers may be referred to as “an isobutylene based elastomer” and refers to an elastomer or a polymer comprising at least 70 mol % isobutylene derived units. One embodiment of the isobutylene based butyl rubber polymer useful in the invention is obtained by reacting 92 to 99.5 wt % of isobutylene with 0.5 to 8 wt % isoprene, or 95 to 99.5 wt % isobutylene with 0.5 wt % to 5.0 wt % isoprene in yet another embodiment.

The elastomer may also be a random copolymer comprising a C4 to C7 isoolefin derived units and alkystrene derived units, the copolymer containing at least 85%, more alternatively at least 86.5 wt % of the isoolefin units, about 5% to about 12 wt % alkylstyrene units, and optionally about 1.1% to about 1.5 wt % of a halogen. In one embodiment, the polymer may be a random elastomeric copolymer of a C₄ to C₇ α-olefin and a methylstyrene containing at about 8% to about 12 wt % methylstyrene. The poly(isobutylene-co-p-methylstyrene) polymers are also referred to as IMSM polymers.

Other C₄ to C₇ isoolefin derived unit containing elastomers suitable for use in the present invention include terpolymers comprising the isoolefin and two multiolefins wherein the multiolefins have different backbone structures prior to polymerization. Such terpolymers include both block and random terpolymers of C₄ to C₈ isoolefin derived units, C₄ to C₁₄ multiolefin derived units, and alkylstyrene derived units. One such terpolymers may be formed from isobutylene, isoprene, and alkylstyrene, preferably methylstyrene, monomers. Another suitable terpolymer may be polymerized from isobutylene, cyclopentadiene, and alkylstyrene monomers. Such terpolymers are obtained under cationic polymerization conditions.

Thus, polymers useful herein can be described as copolymers of a C₄ isomonoolefin derived unit, such as an isobutylene derived unit, and at least one other polymerizable unit with non-limiting examples of isobutylene-based elastomers including poly(isobutylene), butyl rubber(isoprene-isobutylene rubber, “IIR”), branched (“star-branched”) butyl rubber, star-branched polyisobutylene rubber, block terpolymers of isoprene-isobutylene-styrene, random copolymers of isobutylene and para-methylstyrene, and random terpolymers of isobutylene, isoprene, and para-methylstyrene.

The elastomers described herein can be halogenated via conventional methods known in the art. For example, conventional bromination is described in detail in U.S. Pat. No. 2,356,128, U.S. Pat. No. 4,474,924, U.S. Pat. No. 4,068,051, U.S. Pat. No. 7,232,872, and U.S. Pat. No. 7,414,101. Halogenation of isobutylene copolymers is also described in U.S. Pat. No. 5,670,582. The halogen wt % in the formed elastomer is from 0.1 to 10 wt % based on the weight of the halogenated elastomer in one embodiment, and from 0.5 to 5 wt % in another embodiment. In yet another embodiment, the halogen wt % of the halogenated rubber is from 1.0 to 2.5 wt %.

Exemplary polymers are characterized by a narrow molecular weight distribution (Mw/Mn) of less than 4.0, alternatively less than 2.5. The copolymers have an exemplary viscosity average molecular weight in the range of from 400,000 up to 2,000,000 and an exemplary number average molecular weight in the range of from 100,000 to 750,000, as determined by gel permeation chromatography.

### Layered Fillers

To form the desired elastomeric nanocomposite, a layered filler is incorporated into the elastomeric polymer. The layered filler is alternatively referred to as a nanofiller due to the size of the filler. Nanofillers have a maximum dimension in the range of from about 0.0001 μm to about 100 μm. The other characteristic of a nanofiller is the high ratio of surface area to volume; this is in distinction to a fine grain carbon black that might have a very small maximum dimension, but which has a low ratio of surface area to volume per grain. This high ratio of surface area to volume provides the nanofiller with a sheet-like structure. Such materials are typically agglomerated, resulting in the layered filler.

The layered filler can be a layered clay. The layered clay preferably belongs to the general class of clay minerals with expanding crystal lattices commonly referred to as a “smectite” or “smectite-type clay.” By way of example, this may include the dioctahedral smectites which consist of montmorillonite, beidellite, and nontronite, and the trioctahedral smectites, which includes saponite, hectorite, and sauconite. Also encompassed are synthetically prepared smectite-clays.

In yet other embodiments, the layered clay may comprise natural or synthetic phyllosilicates, such as montmorillonite, nontronite, beidellite, bentonite, volkonskoite, laponite, hectorite, saponite, sauconite, magadite, kenyaite, stevensite, and the like, as well as vermiculite, halloysite, aluminate oxides, hydrotalcite, and the like. Combinations of any of the previous embodiments are also contemplated. These clays typically have at least one naturally occurring cation, or first cation, such as potassium, calcium, or sodium, present within their galleries that are attracted to the net negative charge of the clay surface. For example, clays like montmorillonite may be mined with a naturally occurring cation such as sodium or calcium. The clays have a cationic exchange capacity (CEC) that relates to the ion exchange capacity of the clay, or the total quantity of positive charge that can be absorbed onto the clay surface, expressed in terms of positive charges per unit mass of colloidal particles. Some CEC values for exemplary clay materials are as follows: montmorillonite clays range from 70 to 150 meq/100 g; hallosite clays range from 40 to 50 meq/100 g; and kaolinite clays ranges from 1 to 10 meq/100 g; wherein the milliequivalent (meq) ratio is defined as the number of milliequivalents of the cation, per 100 grams of clay, 100% active basis.

The layered clays described above can be modified by intercalation or exfoliation by at least one agent, modifier, or surfactant capable of undergoing ion exchange reactions with the anions present at the interlayer surfaces of the layered filler to render the clay more hydrophobic. The agents, modifiers, or surfactants are selected for their capability of undergoing ion exchange reactions with the anions present at the interlayer surfaces of the layered filler. Suitable compounds are cationic surfactants, preferably amines. The amines may be secondary or tertiary amines having the structure N⁺(R¹R²R³) wherein R¹ and R² are the same or different and are independently selected from C₁ to C₂₆ alkyls, C₂ to C₂₆ alkenes, and C₃ to C₂₆ aryls and R³ may be hydrogen, a C₁ to C₂₆ alkyl, a C₂ to C₂₆ alkene, or a C₃ to C₂₆ aryl. In one embodiment, R¹ and R² are independently selected from C₁ to C₈ alkyls, C₂ to C₈ alkenes, and C₃ to C₈ aryls, and R³ is selected from hydrogen, C₉ to C₂₆ alkyls, C₉ to C₂₆ alkenes, and C₉ to C₂₆ aryls. In another embodiment, R¹ and R² are independently selected from C₁ to C₈ alkyls, and C₂ to C₈ alkenes, R³ is selected from hydrogen, C₃ to C₂₆ aryl substitution on a C₁ to C₂₆ alkyl. In another embodiment, R¹ is selected from C₁ to C₈ alkyls, C₂ to C₈ alkenes, and C₃ to C₈ aryls, R² is selected from C₉ to C₂₆ alkyls, C₉ to C₂₆ alkenes, and C₉ to C₂₆ aryls, and R³ is selected from hydrogen, C₁ to C₂₆ alkyls, C₂ to C₂₆ alkenes, and C₃ to C₂₆ aryls. Additionally, in any of these embodiments, any of the above hydrocarbon substitutions on the nitrogen may be further substituted with C₁ to C₂₆ alkyl, halogen (bromine or chlorine), sulfoxy (sulfonate or alkyl sulfonate), thiol, alkylthiol, and hydroxyl.

Alternatively, the amine may be a quaternary amine, structurally described as follows:

(R¹R²R³R⁴)N⁺

wherein R¹, R², R³, and R⁴ are the same or different and are independently selected from C₁ to C₂₆ alkyls, C₂ to C₂₆ alkenes, and C₃ to C₂₆ aryls. In one embodiment, R¹ and R² are independently selected from C₁ to C₈ alkyls, C₂ to C₈ alkenes, and C₃ to C₈ aryls, and R³ and R⁴ are independently selected from C₉ to C₂₆ alkyls, C₉ to C₂₆ alkenes, and C₉ to C₂₆ aryls. In another embodiment, R¹ and R² are independently selected from C₁ to C₈ alkyls, and C₂ to C₈ alkenes, R³ is selected from C₉ to C₂₆ alkyls, and C₉ to C₂₆ alkenes, and R⁴ is a C₃ to C₂₆ aryl substitution on a C₁ to C₂₆ alkyl. In another embodiment, R¹ is selected from C₁ to C₈ alkyls, C₂ to C₈ alkenes, and C₃ to C₈ aryls, R² is selected from C₉ to C₂₆ alkyls, C₉ to C₂₆ alkenes, and C₉ to C₂₆ aryls, and R³ and R⁴ are the same or different and are independently selected from C₁ to C₂₆ alkyls, C₂ to C₂₆ alkenes, and C₃ to C₂₆ aryls. Additionally, in any of these embodiments, any of the above hydrocarbon substitutions on the nitrogen may be further substituted with C₁ to C₂₆ alkyl, halogen (bromine or chlorine), sulfoxy (sulfonate or alkyl sulfonate), thiol, alkylthiol, and hydroxyl.

Suitable quaternary ammoniums include, but are not limited to, dialkyl di-hydrogenated tallow ammonium, trialkyl hydrogenated tallow ammonium, dimethyl di-hydrogenated tallow ammonium, benzyl trialkyl ammonium, methyl benzyl dialkyl ammonium, methyl benzyl di-hydrogenated tallow ammonium, dimethyl benzyl hydrogenated tallow ammonium, and dibenzyl dialkyl ammonium.

The amount of exfoliated layered filler incorporated in the nanocomposites in accordance with certain embodiments is sufficient to develop an improvement in the mechanical properties or barrier properties of the nanocomposite, for example, tensile strength or oxygen permeability. Amounts generally will range from 0.5 to 20 wt % in one embodiment, from 1 to 15 wt % in another embodiment, from 1 to 10 wt % in another embodiment, and from 1 to 5 wt % in another embodiment, based on the polymer content of the nanocomposite. Expressed in parts per hundred rubber, the exfoliated layered filler is present in the nanocomposite within the range from 4 or 5 phr to 6 or 7 or 8 or 10 or 15 phr.

### Method of Preparing Elastomeric Nanocomposites

Elastomeric nanocomposites can be formed using a variety of processes, such as emulsion blending, solution blending, and melt blending. However, by no means are these processes exhaustive of nanocomposite productions.

### Melt Blending

The nanocomposite of the present invention can be formed by a polymer melt blending process. Blending of the components can be carried out by combining the polymer components and the layered filler in the form of an intercalate in any suitable mixing device such as a Banbury™ mixer, Brabender™ mixer or preferably a mixer/extruder and mixing at temperatures in the range of 120° C. up to 300° C. under conditions of shear sufficient to allow the clay intercalate to exfoliate and become uniformly dispersed within the polymer to form the nanocomposite.

### Emulsion Processes

The nanocomposite of the present invention can be formed by an emulsion process. In the emulsion process, an aqueous slurry of inorganic filler is mixed with a polymer dissolved in a solvent (cement). The mixing should be sufficiently vigorous to form emulsions or micro-emulsions. In some embodiments, the emulsions can be formed as an aqueous solution or suspension in an organic solution. Standard methods and equipment for both lab and large-scale production, including batch and continuous processes may be used to produce the polymeric nanocomposites of the invention.

In certain embodiments, a nanocomposite is produced by a process comprising contacting Solution A comprising water and at least one layered filler with Solution B comprising a solvent and at least one elastomer; and removing the solvent and water from the contact product of Solution A and Solution B to recover a nanocomposite. In certain embodiments, the emulsion is formed by subjecting the mixture to agitation using a high-shear mixer.

In some embodiments, a nanocomposite is produced by a process comprising contacting Solution A comprising water and at least one layered filler with Solution B comprising a solvent and at least one elastomer, wherein the contacting is performed in the presence of an emulsifier or surfactant.

The emulsions are formed by subjecting a mixture of the hydrocarbon, water and surfactant when used, to sufficient shearing, as in a commercial blender or its equivalent for a period of time sufficient for forming the emulsion, e.g., generally at least a few seconds. The emulsion can be allowed to remain in emulsion form, with or without continuous or intermittent mixing or agitation, with or without heating or other temperature control, for a period sufficient to enhance exfoliation of the clay, from 0.1 to 100 hours or more in one embodiment, from 1 to 50 hours in another embodiment, and from 2 to 20 hours in another embodiment.

When used, the surfactant concentration is sufficient to allow the formation of a relatively stable emulsion. Preferably, the amount of surfactant employed is at least 0.001 wt % of the total emulsion, more preferably about 0.001 to about 3 wt %, and most preferably 0.01 to less than 2 wt %.

Cationic surfactants useful in preparing the emulsions of this invention include tertiary amines, diamines, polyamines, amines, as well as quaternary ammonium compounds. Non-ionic surfactants useful in preparing the emulsions of this invention include alkyl ethoxylates, linear alcohol ethoxylates, alkyl glucosides, amide ethoxylates, amine ethoxylates (coco-, tallow-, and oleyl-amine ethoxylates for example), phenol ethoxylates, and nonyl phenol ethoxylates.

### Solution Blending

The nanocomposite of the present invention can be formed by a solution blending process. In the solution process, a nanocomposite is produced by contacting Solution A comprising a hydrocarbon solvent and at least one layered nanofiller or clay with Solution B comprising a solvent and at least one elastomer, and removing the solvents from the contact product of Solution A and Solution B to form a nanocomposite.

The layered nanofiller may be a layered clay treated with organic molecules as described above. In yet another embodiment, a nanocomposite is produced by a process comprising contacting at least one elastomer and at least one layered filler in a solvent; and removing the solvent from the contact product to form a nanocomposite.

In another embodiment, a nanocomposite is produced by a process comprising contacting at least one elastomer and at least one layered filler in a solvent mixture comprising two solvents; and removing the solvent mixture from the contact product to form a nanocomposite.

In still another embodiment, a nanocomposite is produced by a process comprising contacting at least one elastomer and at least one layered filler in a solvent mixture comprising at least two or more solvents; and removing the solvent mixture from the contact product to form a nanocomposite.

In another embodiment, a nanocomposite is produced by a process to form a contact product comprising dissolving at least one elastomer and then dispersing at least one layered filler in a solvent or solvent mixture comprising at least two solvents; and removing the solvent mixture from the contact product to form a nanocomposite.

In yet another embodiment, a nanocomposite is produced by a process to form a contact product comprising dispersing at least one layered filler and then dissolving at least one elastomer in a solvent or solvent mixture comprising at least two solvents; and removing the solvent mixture from the contact product to form a nanocomposite. The solvent mixture is removed from the contact product during the polymer drying process.

In the embodiments described above, solvents may be present in the production of the nanocomposite composition from 30 to 99 wt %, alternatively from 40 to 99 wt %, alternatively from 50 to 99 wt %, alternatively from 60 to 99 wt %, alternatively from 70 to 99 wt %, alternatively from 80 to 99 wt %, alternatively from 90 to 99 wt %, alternatively from 95 to 99 wt %, based upon the total weight of the composition. Additionally, in certain embodiments, when two or more solvents are prepared in the production of the nanocomposite composition, each solvent may comprise from 0.1 to 99.9 vol %, alternatively from 1 to 99 vol %, alternatively from 5 to 95 vol %, and alternatively from 10 to 90 vol %, with the total volume of all solvents present at 100 vol %.

Suitable solvents include hydrocarbons such as alkanes, including C₄ to C₂₂ linear, cyclic, branched alkanes, alkenes, aromatics, and mixtures thereof. Examples include propane, isobutane, pentane, methycyclopentane, isohexane, 2-methylpentane, 3-methylpentane, 2-methylbutane, 2,2-dimethylbutane, 2,3-dimethylbutane, 2-methylhexane, 3-methylhexane, 3-ethylpentane, 2,2-dimethylpentane, 2,3-dimethylpentane, 2,4-dimethylpentane, 3,3-dimethyl pentane, 2-methylheptane, 3-ethylhexane, 2,5-dimethylhexane, 2,24,-trimethylpentane, octane, heptane, butane, ethane, methane, nonane, decane, dodecane, undecane, hexane, methyl cyclohexane, cyclopropane, cyclobutane, cyclopentane, methylcyclopentane, 1,1-dimethylcycopentane, cis 1,2-dimethylcyclopentane, trans-1,2-dimethylcyclopentane, trans-1,3-dimethylcyclopentane, ethylcyclopentane, cyclohexane, methylcyclohexane, benzene, toluene, xylene, ortho-xylene, para-xylene, meta-xylene, and mixtures thereof.

In another embodiment, suitable solvents include one or more nitrated alkanes, including C₂ to C₂₂ nitrated linear, cyclic, or branched alkanes. Nitrated alkanes include, but are not limited to nitromethane, nitroethane, nitropropane, nitrobutane, nitropentane, nitrohexane, nitroheptane, nitrooctane, nitrodecane, nitrononane, nitrododecane, nitroundecane, nitrocyclomethane, nitrocycloethane, nitrocyclopropane, nitrocyclobutane, nitrocyclopentane, nitrocyclohexane, nitrocycloheptane, nitrocyclooctane, nitrocyclodecane, nitrocyclononane, nitrocyclododecane, nitrocycloundecane, nitrobenzene, and the di- and tri-nitro versions of the above, and mixtures thereof.

In another embodiment, suitable solvents include at least one oxygenate, including C₁ to C₂₂ alcohols, ketones, ethers, carboxylic acids, esters, and mixtures thereof. Other suitable solvents are further described in WO 2006/085957.

Halogenated versions of all of the above may also be used such as chlorinated hydrocarbons, for example, methyl chloride, methylene chloride, ethyl chloride, propyl chloride, butyl chloride, chloroform, and mixtures thereof.

### Ionomer Stabilizers

The term “ionomer stabilizer(s)” as used herein refers to, but is not limited to, any organic proton donor. Non-limiting examples of suitable ionomer stabilizers that can be used in the present invention include carboxylic acids; including fatty acids such as stearic acid; mineral and organic acids having pKa less than 9.0 such as phenol, citric acid, monopotassium phosphate, and perchloric acid; and polymer resins with acidic functional groups.

As described above, stearic acid is one of the components for tire manufacturing used in innerliner compounding formulation. Rubber compounds generally use a combination of zinc oxide and stearic acid as part of the curative package to improve the rate and efficiency of accelerated sulfur vulcanization. It is expected that adding stearic acid as the ionomer stabilizer to improve the stability of Mooney viscosity can also serve to reduce the amount of stearic acid necessary for curative purposes. Because stearic acid is an additive in commercial innerliner compound processing, adding stearic acid to the nanocomposite should not change the composition and properties of the final elastomeric nanocomposite composition.

The location of adding the ionomer stabilizer depends on the type of ionomer stabilizer added. For instance, fatty acids having eight or more carbon atoms, such as stearic acid, tend to have low solubility in water and therefore can be added to the polymer solution while the polymer is dissolved in a solvent, i.e. before steam stripping. In contrast, fatty acids having less than eight carbon atoms tend to have high enough water solubility that it is preferable to add after steam stripping, such as during the polymer drying process.

The amount of ionomer stabilizer added to the elastomer is within the range of about 0.5 to 2 phr of the composition, as high amounts of fatty acids having eight or more carbon atoms may increase permeation rate of gases through a cured rubber compound. It may be possible to counter this increased permeation rate by reducing the amount of processing oil that is used in making the rubber compound. Preferably, the ionomer stabilizer added to the elastomer is within the range of 0.75 phr or 1 phr or 1.25 phr or 1.5 to less than about 1.75 phr or 2.0 phr.

### Compounding Additives

Prior to or after adding one or more of the above mentioned ionomer stabilizers, the elastomeric nanocomposite may be blended with additional components to achieve a fully compounded elastomer. Possible additional components includes conventional fillers, nanofillers, processing aids and oils, and cure packages.

Conventional elastomeric fillers are, for example, calcium carbonate, silica, non-organic clay, talc, titanium dioxide, and carbon black. One or more of the fillers may be used. As used herein, silica is meant to refer to any type or particle size silica or another silicic acid derivative, or silicic acid, processed by solution, pyrogenic or the like methods and having a surface area, including untreated, precipitated silica, crystalline silica, colloidal silica, aluminum or calcium silicates, fumed silica, and the like.

In one embodiment, the filler is carbon black or modified carbon black, and combinations of any of these. In another embodiment, the filler is a blend of carbon black and silica. Conventional filler amounts for tire treads and sidewalls is reinforcing grade carbon black present at a level of from 10 to 100 phr of the blend, more preferably from 30 to 80 phr in another embodiment, and from 50 to 80 phr in yet another embodiment.

### Crosslinking Agents, Curatives, Cure Packages, and Curing Processes

Generally, polymer blends, for example, those used to produce tires, are crosslinked thereby improving the polymer's mechanical properties. It is known that the physical properties, performance characteristics, and durability of vulcanized rubber compounds are directly related to the number (crosslink density) and type of crosslinks formed during the vulcanization reaction.

In certain embodiments of the present invention, the elastomeric compositions and the articles made from those compositions may comprise at least one curative or crosslinking agent to enable the elastomer to undergo a process to cure the elastomeric composition. As used herein, at least one curative package refers to any material or method capable of imparting cured properties to a rubber as commonly understood in the industry. At least one curative package may include any and at least one of the following.

One or more crosslinking agents are preferably used in the elastomeric compositions of the present invention, especially when silica is the primary filler, or is present in combination with another filler. Suitable curing components include sulfur, metal oxides, organometallic compounds, and radical initiators.

Peroxide cure systems or resin cure systems may also be used. However, if the elastomer is being combined with a thermoplastic to form a DVA (where no crosslinking of the thermoplastic is desired), the use of peroxide curative may be avoided if the thermoplastic resin is one such that the presence of peroxide would cause the thermoplastic resin to crosslink.

Sulfur is the most common chemical vulcanizing agent for diene-containing elastomers. It exists as a rhombic eight member ring or in amorphous polymeric forms. A typical sulfur vulcanization system consists of the accelerator to activate the sulfur, an activator, and a retarder to help control the rate of vulcanization. The accelerator serves to control the onset of and rate of vulcanization, and the number and type of sulfur crosslinks that are formed. Activators may also be used in combination with the curative and accelerator. The activate reacts first with the accelerators to form rubber-soluble complexes which then react with the sulfur to form sulfurating agents. General classes of activators include amines, diamines, guanidines, thioureas, thiazoles, thiurams, sulfenamides, sulfenimides, thiocarbamates, xanthates, and the like. Retarders may be used to delay the initial onset of cure in order to allow sufficient time to process the unvulcanized rubber.

Halogen-containing elastomers such as halogenated poly(isobutylene-co-p-methylstyrene) may be crosslinked by their reaction with metal oxides. The metal oxide is thought to react with halogen groups in the polymer to produce an active intermediate which then reacts further to produce carbon-carbon bonds. Metal halides are liberated as a by-product and can serve as autocatalysts for this reaction. Common curatives include ZnO, CaO, MgO, Al2O3, CrO3, FeO, Fe2O3, and NiO. These metal oxides can be used alone or in conjunction with the corresponding metal fatty acid complex (e.g., the stearate salts of Zn, Ca, Mg, and Al), or with stearic acid and either a sulfur compound or an alkylperoxide compound. More preferably, the coupling agent may be a bifunctional organosilane crosslinking agent. An “organosilane crosslinking agent” is any silane coupled filler and/or crosslinking activator and/or silane reinforcing agent known to those skilled in the art including, but not limited to, vinyl triethoxysilane, vinyl-tris-(beta-methoxyethoxy)silane, methacryloylpropyltrimethoxysilane, gamma-amino-propyl triethoxysilane (sold commercially as A1100 by Witco), gamma-mercaptopropyltrimethoxysilane (A189 by Witco) and the like, and mixtures thereof. In one embodiment, bis-(3-triethoxysilypropyl)tetrasulfide (sold commercially as “Si69”) is employed.

The mechanism for accelerated vulcanization of elastomers involves complex interactions between the curative, accelerator, activators and polymers. Ideally, all available curative is consumed in the formation of effective crosslinks which join together two polymer chains and enhance the overall strength of the polymer matrix. Numerous accelerators are known in the art and include, but are not limited to, the following: stearic acid, diphenyl guanidine, tetramethylthiuram disulfide, 4,4′-dithiodimorpholine, tetrabutylthiuram disulfide, benzothiazyl disulfide, hexamethylene-1,6-bisthiosulfate disodium salt dihydrate (sold commercially as DURALINK™ HTS by Flexsys), 2-morpholinothio benzothiazole (MBS or MOR), blends of 90% MOR and 10% MBTS (MOR 90), N-tertiarybutyl-2-benzothiazole sulfenamide, and N-oxydiethylene thiocarbamyl-N-oxydiethylene sulfonamide, zinc 2-ethyl hexanoate, and thioureas.

Elastomeric compositions typically contain other components and additives customarily used in rubber mixes, such as effective amounts of other nondiscolored and nondiscoloring processing aids, processing oils, pigments, antioxidants, and/or antiozonants.

### Secondary Elastomers

In one embodiment, the elastomeric nanocomposite as discussed above may be the sole elastomeric component of a compound; thereby taking full advantage of the above noted benefits. Alternatively, in other embodiments, the copolymer may be blended with a different/secondary elastomeric polymer to obtain a compound having other desired properties or characteristics.

Examples of other elastomeric polymers, or general purpose rubbers, include natural rubbers (NR), polybutadiene rubber (BR), polyisoprene rubber (IR), poly(styrene-co-butadiene) rubber (SBR), poly(isoprene-co-butadiene) rubber (IBR), styrene-isoprene-butadiene rubber (SIBR), ethylene-propylene rubber (EPM), ethylene-propylene-diene rubber (EPDM), and mixtures thereof

When blended in a compound, the presently disclosed elastomer, either individually or as a blend of different elastomers (i.e., reactor blends, physical blends such as by melt mixing), may be present in the composition from 10 phr to 90 phr in one embodiment, and from 10 to 80 phr in another embodiment, and from 30 to 70 phr in yet another embodiment, and from 40 to 60 phr in yet another embodiment, and from 5 to 50 phr in yet another embodiment, and from 5 to 40 phr in yet another embodiment, and from 20 to 60 phr in yet another embodiment, and from 20 to 50 phr in yet another embodiment, the chosen embodiment depending upon the desired end use application of the composition.

Such secondary rubbers may be present in the final composition in amounts ranging from 5 to 90 phr. To obtain a greater impermeability, the use of polymers having lesser permeability characteristics will be limited to minor amounts, i.e., less than 50 phr, in the elastomeric blend.

### EXAMPLES

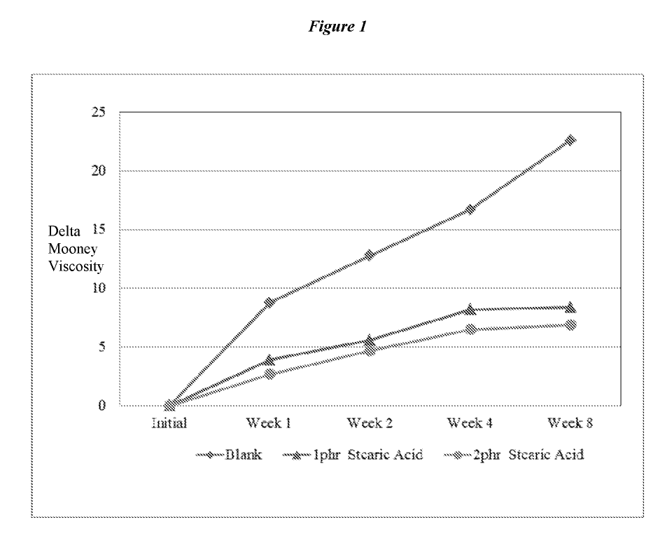

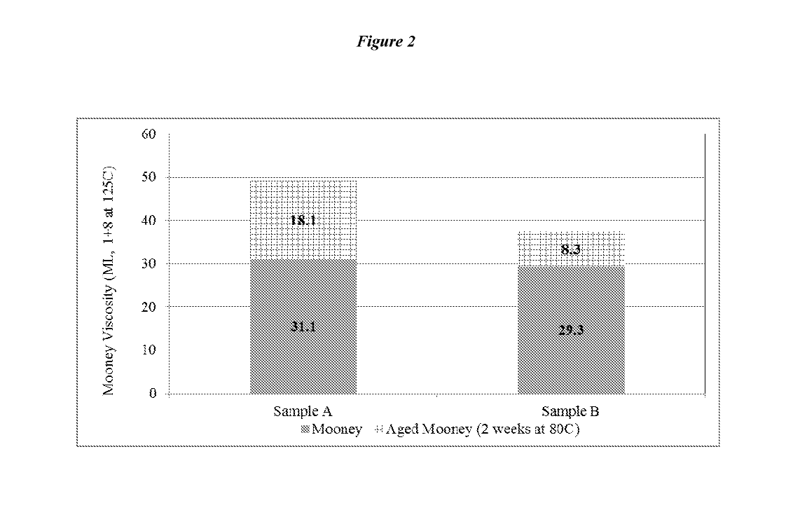

The following procedure was specifically used in the preparation of elastomeric nanocomposite compositions within the scope of the present invention as set forth in the description below and as shown in FIG. 1 and FIG. 2.

The elastomeric nanocomposite was prepared by mixing an organoclay with an elastomer cement in hexane solution, then steam stripping, dewatering, and drying the resulting product. 250 g (110 phr) of the nanocomposite was preheated in a Brabender™ at 125° C. at 60 rpm for 1 minute. The preheated composition and stearic acid (the ionomer stabilizer) were blended in a Brabender™ mixer at 125° C. at 60 rpm for 5 minutes. A control sample having no ionomer stabilizer was also mixed in the Brabender™ (labeled as Blank in FIG. 1).

The blended composition was placed in an oven at 80° C. for the aging study. The samples aged at 80° C. for 7 days are expected to exhibit properties similar to compositions in warehouse conditions for 1 year. The samples aged at 80° C. for 14 days are expected to exhibit properties similar to compositions in warehouse conditions for 2 years. The samples aged at 80° C. for 28 days are expected to exhibit properties similar to compositions in warehouse conditions for 4 years. The samples aged at 80° C. for 56 days are expected to exhibit properties similar to compositions in warehouse conditions for 8 years.

Samples were taken in intervals of 0, 7, 14, 28, and 56 days at 80° C. and tested for Mooney viscosity in accordance with ASTM 1646. The change in Mooney viscosity was calculated to determine the effect of adding the ionomer stabilizer to the nanocomposite.

FIG. 1 shows the change in Mooney viscosity of the nanocomposite composition with the addition of 1 phr and 2 phr of stearic acid. Adding stearic acid, in 1 phr or 2 phr amounts, show lower increases in Mooney compared to the control sample (Blank) without stearic acid. Adding 1 phr of stearic acid to the nanocomposite polymer showed up to a 50% improvement in Mooney stability as compared to not adding any stearic acid. Adding 2 phr of stearic acid to the polymer does not show significant improvement in Mooney stability as compared to adding 1 phr.

As described above, stearic acid also serves as a plasticizer and/or lubricant to reduce the compounded polymer viscosity for easy processing. However, lubricants added to the polymer decrease polymer's impermeability. MOCON is a tool generally used to measure a polymer permeability test. Based on a MOCON study, the permeability of a nanocomposite polymer having no stearic acid has permeability of about 105, polymer having 1 phr has a permeability of about 101, and polymer having 2 phr of stearic acid has a permeability of about 100. Accordingly, it is expected that there is no significant difference in permeability of the polymer between samples having 0, 1, and 2 phr of stearic acid. However, as described above, adding stearic acid above 2 phr may unfavorably increase permeation rate of gases through a cured rubber compound.

FIG. 2 shows the change in Mooney viscosity with the addition of 2 phr stearic acid prior to compounding. As described above, rubber formulators generally add stearic acid to prepared bromobutyl elastomers as part of the curative package. Sample A of FIG. 2 was prepared without adding any stearic acid as an ionomer stabilizer and only adding 1 phr of stearic acid in the compounding stage as part of the curative package. Sample B of FIG. 2 was prepared by the method described herein by adding 2 phr as an ionomer stabilizer and not adding any stearic acid in the compounding stage as part of the curative package. Samples A and B were aged for 2 weeks at 80° C. and tested for Mooney growth. Aged Sample B showed an improvement in Mooney Stability by about 50% in comparison to aged Sample A. Accordingly, adding an ionomer stabilizer, such as stearic acid, during the process of preparing the elastomeric nanocomposite provides improved Mooney stability as compared to adding during the compounding stage.

### INDUSTRIAL APPLICABILTY

The elastomeric compositions of the invention may be extruded, compression molded, blow molded, injection molded, and laminated into various shaped articles including fibers, films, laminates, layers, industrial parts such as automotive parts, appliance housings, consumer products, packaging, and the like.

The elastomeric compositions as described above may be used in the manufacture of air membranes such as innerliners, innertubes sidewalls, treads, bladders, and the like used in the production of tires. Methods and equipment used to manufacture the innerliners and tires are well known in the art. The invention is not limited to any particular method of manufacture for articles such as innerliners or tires. In particular, the elastomeric compositions are useful in articles for a variety of tire applications such as truck tires, bus tires, automobile tires, motorcycle tires, off-road tires, aircraft tires, and the like.

In another application, the elastomeric compositions may be employed in air cushions, pneumatic springs, air bellows, hoses, accumulator bags, and belts such as conveyor belts or automotive belts. They are useful in molded rubber parts and find wide applications in automobile suspension bumpers, auto exhaust hangers, and body mounts.

Additionally, the elastomeric compositions may also be used as adhesives, caulks, sealants, and glazing compounds. They are also useful as plasticizers in rubber formulations; as components to compositions that are manufactured into stretch-wrap films; as dispersants for lubricants; and in potting and electrical cable filling materials.

All priority documents, patents, publications, and patent applications, test procedures (such as ASTM methods), and other documents cited herein are fully incorporated by reference to the extent such disclosure is not inconsistent with this invention and for all jurisdictions in which such incorporation is permitted.

When numerical lower limits and numerical upper limits are listed herein, ranges from any lower limit to any upper limit are contemplated.

### Specific Embodiments

The invention, accordingly, provides the following embodiments:

Paragraph A: An elastomeric nanocomposite composition, the composition comprising at least one elastomer, at least one nanofiller, and an ionomer stabilizer in the amount of at least about 0.5 phr of the composition, the elastomer comprising units derived from isoolefins having from 4 to 7 carbon atoms and at least one multiolefin, wherein the Mooney viscosity (ML, 1+8 at 125° C.) of the composition does not increase by more than about 7.5 Mooney units for up to about 8 weeks at 80° C.

Paragraph B: The composition of Paragraph A wherein the Mooney viscosity (ML, 1+8 at 125° C.) of the composition does not increase by more than about 5 Mooney units for up to about 2 weeks at 80° C.

Paragraph C: The composition of Paragraph A or B wherein the ionomer stabilizer is added during the preparation of the composition.

Paragraph D: The composition of Paragraph A or any one or any combination of Paragraphs B to C wherein the ionomer stabilizer is selected from the group consisting of carboxylic acids, mineral and organic acids having pKa less than 9.0, citric acid, monopotassium phosphate, perchloric acid, polymer resins with acidic functional groups, and combinations thereof

Paragraph E: The composition of Paragraph A or any one or any combination of Paragraphs B-D wherein the composition is prepared with a nanofiller that is either acid treated or not acid treated, and the ionomer stabilizer is added during the preparation of the composition.

Paragraph F: The composition of Paragraph A or any one or any combination of Paragraphs B-E wherein the at least one multiolefin is selected from the group consisting of isoprene, butadiene, 2,3-dimethyl-1,3-buadiene, myrcene, 6,6-dimethyl-fulvene, hexadiene, cyclopentadiene, methylcyclopentadiene, alkylstyrene, piperylene, and combinations thereof.

Paragraph G: The composition of Paragraph A or any one or any combination of Paragraphs B-F wherein the elastomer is halogenated with either chlorine or bromine.

Paragraph H: The composition of Paragraph A or any one or any combination of Paragraphs B-G wherein the nanocomposite is blended with at least one component selected from the group consisting of fillers, processing oils, processing aids, and cure packages.

Paragraph I: The composition of Paragraph A or any one or any combination of Paragraphs B-H wherein the nanocomposite is blended with a thermoplastic polymer selected from the group consisting of polyamides, polyimides, polycarbonates, polyesters, polysulfones, polylactones, polyacetals, acrylonitrile-butadiene-styrene polymers, polyphenyleneoxide, polyphenylene sulfide, polystyrene, styrene-acrylonitrile polymers, styrene maleic anhydride polymers, aromatic polyketones, poly(phenylene ether), and mixtures thereof.

Paragraph J: The composition of Paragraph I wherein the nanocomposite and the thermoplastic polymer are dynamically vulcanized together under conditions of high shear wherein the nanocomposite is dispersed as fine particles within the thermoplastic polymer.

Paragraph K: The composition of Paragraph A or any one or any combination of Paragraphs B-I wherein the nanofiller comprises a silicate and is selected from the group consisting of montmorillonite, nontronite, beidellite, bentonite, volkonskoite, laponite, hectorite, saponite, sauconite, magadite, kenyaite, stevensite, vermiculite, halloysite, aluminate oxides, hydrotalcite, and combinations thereof.

Paragraph L: An article comprising the composition of Paragraph A or any one or any combination of Paragraphs B-K, wherein the article is a tire innerliner or a tire bladder or is incorporated as a layer into a tire, a bladder, a hose, a belt, pneumatic spring, or vehicle body mount.

Paragraph M: The composition of Paragraph A or any one or any combination of Paragraphs B-L, wherein the layered filler of the nanofiller is an organoclay.

Paragraph N: A method of stabilizing the Mooney viscosity of an elastomeric nanocomposite composition, the method comprising obtaining an elastomeric nanocomposite, the nanocomposite comprising at least one elastomer comprising units derived from iosolefins having from 4 to 7 carbon atoms and at least one nanofiller; adding to the nanocomposite an ionomer stabilizer in the amount of at least about 0.5 phr of the composition to obtain a composition, wherein the Mooney viscosity (ML, 1+8 at 125° C.) of the composition does not increase by more than about 7.5 Mooney units for up to about 8 weeks at 80° C.

Paragraph O: The method of Paragraph N wherein the Mooney viscosity (ML, 1+8 at 125° C.) of the composition does not increase by more than about 5 Mooney units for up to about 2 weeks at 80° C.

Paragraph P: The method of Paragraph N or O wherein the ionomer stabilizer is added during the preparation of the composition.

Paragraph Q: The method of Paragraph N or any one or any combination of Paragraphs O-P wherein the ionomer stabilizer is selected from the group consisting of carboxylic acids, mineral and organic acids having pKa less than 9.0, citric acid, monopotassium phosphate, perchloric acid, polymer resins with acidic functional groups, and combinations thereof.

Paragraph R: The method of Paragraph N or any one or any combination of Paragraphs O-Q wherein the composition is prepared with a layered filler that is either acid treated or not acid treated, and the ionomer stabilizer is added during the preparation of the composition.

Paragraph S: The method of Paragraph N or any one or any combination of Pargraphs O-R wherein the at least one multiolefin is selected from the group consisting of isoprene, butadiene, 2,3-dimethyl-1,3-buadiene, myrcene, 6,6-dimethyl-fulvene, hexadiene, cyclopentadiene, methylcyclopentadiene, alkylstyrene, piperylene, and combinations thereof.

Paragraph T: The method of Paragraph N or any one or any combination of Paragraphs O-S wherein the elastomer is halogenated with either chlorine or bromine.

Paragraph U: The method of Paragraph N or any one or any combination of Paragraphs O-T wherein the nanocomposite is blended with at least one component selected from the group consisting of fillers, processing oils, processing aids, and cure packages.

Paragraph V: The method of Paragraph N or any one or any combination of Paragraphs O-U wherein the nanocomposite is blended with a thermoplastic polymer selected from the group consisting of polyamides, polyimides, polycarbonates, polyesters, polysulfones, polylactones, polyacetals, acrylonitrile-butadiene-styrene polymers, polyphenyleneoxide, polyphenylene sulfide, polystyrene, styrene-acryloni-trile polymers, styrene maleic anhydride polymers, aromatic polyketones, poly(phenylene ether), and mixtures thereof.

Paragraph W: The method of Paragraph V wherein the nanocomposite and the thermoplastic polymer are dynamically vulcanized together under conditions of high shear wherein the nanocomposite is dispersed as fine particles within the thermoplastic polymer.

Paragraph X: The method of Paragraph N or any one or any combination of Paragraphs O-W wherein the nanofiller is at least one silicate and is selected from the group consisting of montmorillonite, nontronite, beidellite, bentonite, volkonskoite, laponite, hectorite, saponite, sauconite, magadite, kenyaite, stevensite, vermiculite, halloysite, aluminate oxides, hydrotalcite, and combinations thereof.

Certain embodiments and features have been described using a set of numerical upper limits and a set of numerical lower limits. It should be appreciated that ranges from any lower limit to any upper limit are contemplated unless otherwise indicated. Certain lower limits, upper limits, and ranges appear in one or more claims below. All numerical values are “about” or “approximately” the indicated value, and take into account experimental error and variations that would be expected by a person having ordinary skill in the art.

To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

1. An elastomeric nanocomposite composition, the composition consisting essentially of at least one elastomer, at least one nanofiller, an ionomer stabilizer in the amount of at least about 0.5 phr of the composition, and optional nanofiller modifiers, the elastomer comprising units derived from isoolefins having from 4 to 7 carbon atoms and at least one multiolefin, wherein the Mooney viscosity (ML, 1+8 at 125° C.) of the composition does not increase by more than about 7.5 Mooney units for up to about 8 weeks at 80° C.

2. The composition of claim 1, wherein the Mooney viscosity (ML, 1+8 at 125° C.) of the elastomeric nanocomposite composition does not increase by more than about 5 Mooney units for up to about 2 weeks at 80° C.

3. The composition of claim 1, wherein the ionomer stabilizer is added during the preparation of the elastomeric nanocomposite composition.

4. The composition of claim 1, wherein the ionomer stabilizer is selected from the group consisting of carboxylic acids, mineral and organic acids having pKa less than 9.0, citric acid, monopotassium phosphate, perchloric acid, polymer resins with acidic functional groups, and combinations thereof.

5. The composition of claim 1, wherein the elastomeric nanocomposite composition is prepared with a nanofiller that is either acid treated or not acid treated, and the ionomer stabilizer is added during the preparation of the elastomeric nanocomposite composition.

6. The composition of claim 1, wherein the at least one multiolefin is selected from the group consisting of isoprene, butadiene, 2,3-dimethyl-1,3-buadiene, myrcene, 6,6-dimethyl-fulvene, hexadiene, cyclopentadiene, methylcyclopentadiene, alkylstyrene, piperylene, and combinations thereof.

7. The composition of claim 1, wherein the elastomer is halogenated with either chlorine or bromine.

8. The composition of claim 1, wherein the elastomeric nanocomposite composition is further blended with at least one component selected from the group consisting of fillers, processing oils, processing aids, and cure packages to form a fully formulated composition.

9. The composition of claim 1, wherein the elastomeric nanocomposite composition is further blended with a thermoplastic polymer selected from the group consisting of polyamides, polyimides, polycarbonates, polyesters, polysulfones, polylactones, polyacetals, acrylonitrile-butadiene-styrene polymers, polyphenyleneoxide, polyphenylene sulfide, polystyrene, styrene-acryloni-trile polymers, styrene maleic anhydride polymers, aromatic polyketones, poly(phenylene ether), and mixtures thereof.

10. The composition of claim 9, wherein the elastomeric nanocomposite composition and the thermoplastic polymer are dynamically vulcanized together under conditions of high shear wherein the elastomeric nanocomposite composition is dispersed as fine particles within the thermoplastic polymer.

11. The composition of claim 1, wherein the nanofiller comprises a silicate and is selected from the group consisting of montmorillonite, nontronite, beidellite, bentonite, volkonskoite, laponite, hectorite, saponite, sauconite, magadite, kenyaite, stevensite, vermiculite, halloysite, aluminate oxides, hydrotalcite, and combinations thereof.

12. An article comprising the elastomeric nanocomposite composition of claim 1, wherein the article is a tire innerliner or a tire bladder or is incorporated as a layer into a tire, a bladder, a hose, a belt, pneumatic spring, or vehicle body mount.

13. The composition of claim 1, wherein the layered filler of the nanofiller is an organoclay.

14. A method of stabilizing the Mooney viscosity of an elastomeric nanocomposite composition, the method comprising obtaining an elastomeric nanocomposite, the elastomeric nanocomposite comprising at least one elastomer comprising units derived from iosolefins having from 4 to 7 carbon atoms and at least one nanofiller; adding to the elastomeric nanocomposite an ionomer stabilizer in the amount of at least about 0.5 phr of the composition to obtain a composition, wherein the Mooney viscosity (ML, 1+8 at 125° C.) of the composition does not increase by more than about 7.5 Mooney units for up to about 8 weeks at 80° C.

15. The method of claim 14, wherein the Mooney viscosity (ML, 1+8 at 125° C.) of the elastomeric nanocomposite composition does not increase by more than about 5 Mooney units for up to about 2 weeks at 80° C.

16. The method of claim 14, wherein the ionomer stabilizer is added during the preparation of the elastomeric nanocomposite composition when the elastomer is dissolved in a solvent or during a polymer drying process when the polymer is in water.

17. The method of claim 14, wherein the ionomer stabilizer is selected from the group consisting of carboxylic acids, mineral and organic acids having pKa less than 9.0, citric acid, monopotassium phosphate, perchloric acid, polymer resins with acidic functional groups, and combinations thereof.

18. The method of claim 14, wherein the elastomeric nanocomposite composition is prepared with a layered filler that is either acid treated or not acid treated, and the ionomer stabilizer is added during the preparation of the elastomeric nanocomposite composition.

19. The method of claim 14, wherein the at least one multiolefin is selected from the group consisting of isoprene, butadiene, 2,3-dimethyl-1,3-buadiene, myrcene, 6,6-dimethyl-fulvene, hexadiene, cyclopentadiene, methylcyclopentadiene, alkylstyrene, piperylene, and combinations thereof.

20. The method of claim 14, wherein the elastomer is halogenated with either chlorine or bromine.

21. The method of claim 14, wherein the elastomeric nanocomposite composition is further blended with at least one component selected from the group consisting of fillers, processing oils, processing aids, and cure packages to form a fully formulated composition.

22. The method of claim 14, wherein the elastomeric nanocomposite composition is further blended with a thermoplastic polymer selected from the group consisting of polyamides, polyimides, polycarbonates, polyesters, polysulfones, polylactones, polyacetals, acrylonitrile-butadiene-styrene polymers, polyphenyleneoxide, polyphenylene sulfide, polystyrene, styrene-acrylonitrile polymers, styrene maleic anhydride polymers, aromatic polyketones, poly(phenylene ether), and mixtures thereof.

23. The method of claim 22, wherein the elastomeric nanocomposite composition and the thermoplastic polymer are dynamically vulcanized together under conditions of high shear wherein the elastomeric nanocomposite composition is dispersed as fine particles within the thermoplastic polymer.

24. The method of claim 14, wherein the nanofiller comprises a silicate and is selected from the group consisting of montmorillonite, nontronite, beidellite, bentonite, volkonskoite, laponite, hectorite, saponite, sauconite, magadite, kenyaite, stevensite, vermiculite, halloysite, aluminate oxides, hydrotalcite, and combinations thereof.
